(19) United States
(12) Patent Application Publication
(10) Pub. No.: US 2003/0178847 A1
(43) Pub. Date: Sep. 25, 2003

(54) Threaded connection makeup method

(76) Inventors: Edward M. Galle JR., Kingwood, TX (US); Edward M. Galle SR., Friendswood, TX (US)

Correspondence Address: James E. Bradley, BRACEWELL & PATTERSON, LLP, P.O. Box 61389, Houston, TX, 77208-1389, US

(21) Appl. No.: 10/390,823

(22) Filed: Mar. 18, 2003

Related U.S. Application Data
(60) Provisional application No. 60/365,417, filed on Mar. 19, 2002.

(51) Int. Cl. F16L 35/00

(52) U.S. Cl. 285/333; 285/390

(57) ABSTRACT

A method of making up a pipe connection results in precise axial preload. The pipe connection has a box tubular member and a pin tubular member, each having mating threads and makeup shoulders. The designer determines a desired axial preload interference between the makeup shoulders. Based on this, the designer determines an increment of preload rotation required between the tubular members after initial contact of the makeup shoulders in order to achieve the desired axial preload interference. The tubular members are rotated relative to each other past the initial contact of the makeup shoulders for an amount equal to the increment of preload rotation determined.

### CROSS REFERENCE TO RELATED APPLICATION

This application claims priority to provisional application No. 60/365,417 filed Mar. 19, 2002.

### FIELD OF THE INVENTION

This invention relates in general to a method for making up threaded pipe connections such as oilfield pipe, and particularly to a method of achieving a desired preload through the makeup shoulders.

### BACKGROUND OF THE INVENTION

Threaded connections are typically used in the oilfield and other industries to join various lengths of pipe for a number of purposes. In the type of pipe concerned herein, each section or joint of pipe has a pin on one end that has external threads and a box on the other end that has internal threads. Many threaded connector designs have one or more makeup shoulders on the pin and box, the shoulders being either planar or frusto-conical. The makeup shoulders come together when the connection is screwed together. The makeup shoulders or surfaces may provide sealing of the pipes, but their primary purpose is to allow the connection to be preloaded through generation of high contact forces on the makeup shoulders by further tightening of the connection after the makeup shoulders contact.

The term “preload” refers to the amount of force that passes axially through the makeup shoulders after being made up past initial contact. This amount of preload force should be sufficient to withstand any axial load encountered during use that would otherwise cause separation of the makeup shoulders. The proper generation of these preload forces is very important to connection sealing and fatigue life when the pipe is subsequently subjected to loading.

The amount of preload force is selected based on the pipe loading that would be anticipated. Then, using stress analysis programs such as finite element analysis (“FEA”), the designer determines how much interference between the makeup shoulders is required to achieve the desired preload force. The makeup shoulders will deflect or deform axially during preload, and this deflection is referred to as shoulder interference. Typically, the FEA process is an iteration that involves making an estimate of the desired interference, then calculating the resulting preload using the FEA program, which includes the effects of varying geometry, machining tolerance, friction and the like. Different combinations of these variables are modeled and analyzed to provide an assessment of connector stresses, stress concentration factors, and metal-to-metal seal contact forces to predict proper performance of the connection in the field.

In the past, once the desired makeup shoulder interference is determined from the FEA program, an estimated makeup torque would be selected to approximately achieve that interference. The estimated torque has been determined in the past either by using past experience with similar connections or by computing the makeup torque based on contact forces, the moment arm and the coefficient of friction.

The makeup of threaded connections in the oilfield is typically done using a machine called a power tong, which grips the outer surface of the connection on the box and pin sides of the connection, spins the connection up to the point where the makeup shoulders contact, and then applies the pre-selected amount of torque to generate the preload.

Many connections will exhibit a gradual buildup of resisting torque before the makeup shoulders contact. This is due to increasing interferences between threads or seals or both. These built-in interferences result in frictional forces on the interfering surfaces, causing an increase in the torque required to continue makeup. Most of these interferences are in the radial direction, and since the pin and box are relatively flexible in the hoop direction, the buildup of interference forces is therefore gradual. This slow buildup continues until the makeup shoulders contact. The total amount of torque required to reach the point of shoulder contact is dependent on many factors, including the machined sizes of the pin and box interfering surfaces, which affect the amount of interference. Other factors include stiffness, load path distributions, the surface finish, coatings, lubrication, cleanliness, tong alignment, axial and radial loads on the connection during makeup, temperature, and makeup speed. Because all these variables come into play, the torque required to reach this point varies significantly.

Once the makeup shoulders contact and additional torque is applied to the connection, the torque and preload increase rapidly because of the high relative stiffness of the pin and box in the axial direction. The amount of preload generated in the connection is based on the final applied torque and the efficiency of the threaded joint in translating that torque into useful preload. All of the factors mentioned affect the relationship of the final applied torque and the final connection preload.

As mentioned, in the prior art, manufacturers of threaded connections specify only the makeup torque that must be applied to their connection. This is typically specified as a range of acceptable torque. In some cases, the manufacturer will also specify a minimum amount of torque that must be applied after the makeup shoulders have contacted. For example, one manufacturer may specify that the total preload applied to the connection must be in the range of 25,000 to 30,000 ft. lbs. without regard to how much is before or after shouldering. Another manufacturer may specify that the total preload is 25,000 to 30,000 ft. lbs. and at least 10,000 ft. lbs. must be after the connection has shouldered.

As mentioned, the manufacturer usually determines the recommended makeup torque range by experience or estimation from FEA. However, since there are so many uncontrollable aspects to the makeup process, the manufacturer rarely can quantify the actual amount of axial preload force in any given connection. This is problematic, especially in critical applications where the preload must be known in order to demonstrate to the customer and the appropriate governmental regulatory agencies that the design is adequate for the application.

When made up to a selected torque value, the many variables associated with the makeup process cause the actual preload in the joint to vary quite widely. The measurement of torque is only a vaguely indirect indication that the desired preload exists in the connection. Since preload, not makeup torque, is the engineering variable that is critically important to the performance of the threaded connection, it is extremely desirable to be able to consistently apply a known preload to the connection.

### SUMMARY OF THE INVENTION

This invention provides a method of applying preload by directly measuring and consistently applying the desired axial interference between the makeup shoulders. The axial interference is directly related to the preload generated in the connection, and can be readily determined using stress analysis techniques such as FEA. There is a known relationship in the threaded connection between the thread lead or pitch and required shoulder interference. In this invention, the shouldering contact is detected, then the connection is rotated an incremental amount to reach the desired makeup shoulder interference.

In the first embodiment, the designer determines an incremental amount of preload rotation that is required after initial contact of the makeup shoulders to achieve the desired axial preload interference. The members are stabbed together and then one is rotated while the torque is monitored. The torque will gradually increase during the makeup process. Once initial contact of the makeup shoulders occurs, the rate of increase will suddenly change to a much higher rate. A computer connected with the power tong senses the change in rate and instructs the power tong to rotate the desired increment to preload the connection.

In a second method, again, the designer will determine the desired axial preload interference and also determine the amount of preload rotation required after initial contact to achieve this desired axial preload interference. The manufacturer marks an indicia or symbol on exterior portions of each of the tubular members at positions that align with each other when the incremental amount of preload rotation has occurred. In this method, the operators will manually control the power tongs up to the point where the indicia align with each other.

Preferably the box and pin indicia are marked on the box and pin at a manufacturing or field service facility. Once marked, the box and pin are interchangeable with others. This procedure is preferably performed by using a gauge that has a probe that contacts the threads, a base plate that rests on the makeup shoulder and a micrometer. The manufacturer selects an arbitrary axial distance on one of the joints, and when the gauge determines that the arbitrary axial distance from the thread to the makeup shoulder is reached, he applies a mark to the circumference of the connector member. The gauge for the other tubular member will be set to a distance that corresponds to the pre-selected axial distance of the first tubular member plus the desired axial preload interference. An indicia or mark will be placed at this point.

In the third method, the connectors are not marked at the manufacturing or field service facility. While making up the unmarked pin and box, the operator will screw them together partially to a point before contact of the makeup shoulders. The operator measures the gap between the makeup shoulders at this point. The operator then computes the amount of turns that it would take to close the gap plus the incremental amount of rotation to provide the preload. The operator then measures the rotation until the desired rotational point is reached.

### BRIEF DESCRIPTION OF THE DRAWINGS

FIG. 1 is a vertical sectional view of a typical connector joint that is made up in accordance with this invention.

FIG. 2 is a schematic graph illustrating the typical amount of torque being encountered as the connector joint of FIG. 1 is being rotated to a desired preload interference.

FIG. 3 is a schematic representation of the connector joint of FIG. 1 being secured together by power tongs controlled by a controller.

FIG. 4 is a view of the connector of FIG. 1, but showing indicia marked on the box and pin for making up the connectors to a desired preload without the use of the controller as shown in FIG. 3.

FIG. 5 is a perspective view of a gauge for the box of the connector of FIG. 1 to determine placement of the indicia of FIG. 4.

FIG. 6 is a partially sectional view of the gauge of FIG. 5.

FIG. 7 is a partially sectional view of a gauge for determining the location of the indicia of the pin of FIG. 4.

### DETAILED DESCRIPTION OF THE INVENTION

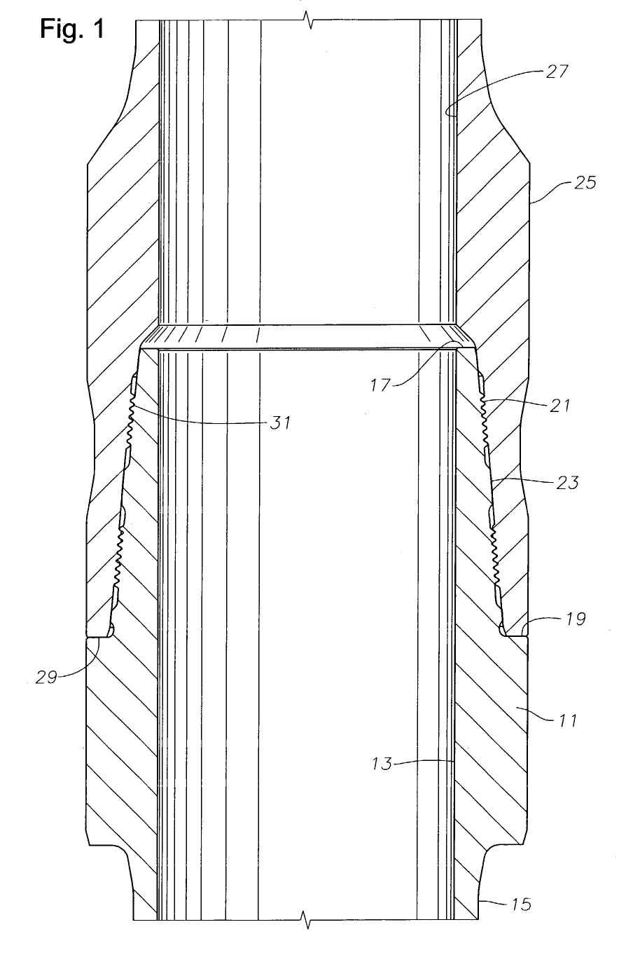

The pipe connection of FIG. 1 is of a type shown in U.S. Pat. No. 6,494,499, but it is merely an example as this invention is operable with many other types of threaded pipe connections. The connection of FIG. 1 has a pin 11 that has a bore 13 and an end 15 welded to a joint of pipe. A nose 17 is located at the opposite end. An external makeup shoulder 19 is spaced from nose 17. Makeup shoulder 19 is an annular planar surface, but it could also be other shapes, such as conical. Threads 21 are located between nose 17 and makeup shoulder 19. Threads 21 are shown in two segments separated by band 23, however this feature is not essential to this invention. Both segments of threads 21 are on a single helical path on a single frusto-conical surface of pin 11.

Box 25 has a bore 27 and an external makeup shoulder 29 on its rim or end. Makeup shoulder 29 is also annular and planar for mating with pin makeup shoulder 19. Internal threads 31 on box 25 mate with threads 21.

The connector of FIG. 1 is designed to have an axial preload force. The axial preload force is a parameter that a designer will determine based on the anticipated load in use. The designer then uses a stress analysis program such as finite element analysis (FEA) to determine the desired axial deflection or interference required in order to achieve the axial preload. FEA programs are known in the art and include many variables, such as varying geometry, makeup conditions, machining tolerances, friction, and the like. Based on experience, the designer selects a preload interference, then has the FEA model that selection to determine what type of preload it would generate. If the computed amount of preload is insufficient, the operator will select a higher axial interference to compute a desired preload force. If the calculated preload is too high, the operator will select a lesser axial interference to compute a desired preload force. This process continues iteratively until a makeup shoulder interference is selected that will provide the desired amount of preload force. For example, one type of connector is for pipe that has a 13⅜″ outer diameter, a 0.544″ wall thickness, and a yield strength of 80 ksi. The nominal preload of the connection was computed to be 715,000 lbs., and this preload was achieved by an interference between makeup shoulders 19 and 29 (FIG. 1) of 0.011″ plus or minus 0.001″.

The thread lead for the connection of this example was 0.250″ or four threads per inch. The increment of rotation that must be made after shoulders 19, 29 contact is determined by dividing 0.011″ of axial deflection by 0.250″. This gives an answer of 0.044 plus or minus 0.004 turns, which equates to 15.84 plus or minus 1.44 degrees. Consequently, after shoulders 19, 29 contact, the connection must be turned another 0.040 to 0.048 turns. In terms of circumferential distance, the outer diameter of the connector is 15.875″, thus the circumferential distance that the connector must turn after makeup shoulders 19, 29 contact is pi times 15.875″ times 0.044″ plus or minus 0.004″, equaling 2.194″ plus or minus 0.200″ circumferentially on the outer diameter of the connector.

Referring to FIG. 3 power tongs 33 are typically used to make up the connection of pin 11 and box 25. Power tongs 33 are conventional and have drive members that will rotate one of the members, such as box 25, relative to the other member, this being pin 11. Power tongs 33 also have a torque sensing mechanism, and in this embodiment an electrical controller 35 that includes a computer. Controller 35 controls the amount of rotation of power tongs 33. The computer within controller 35 is programmed to detect a change in the slope of torque versus turns, and if the change is sufficiently high, to then instruct the power tongs 33 to rotate a precise amount after detecting the change in the slope. The operator inputs the amount of rotation required after detecting the sharp increase in torque.

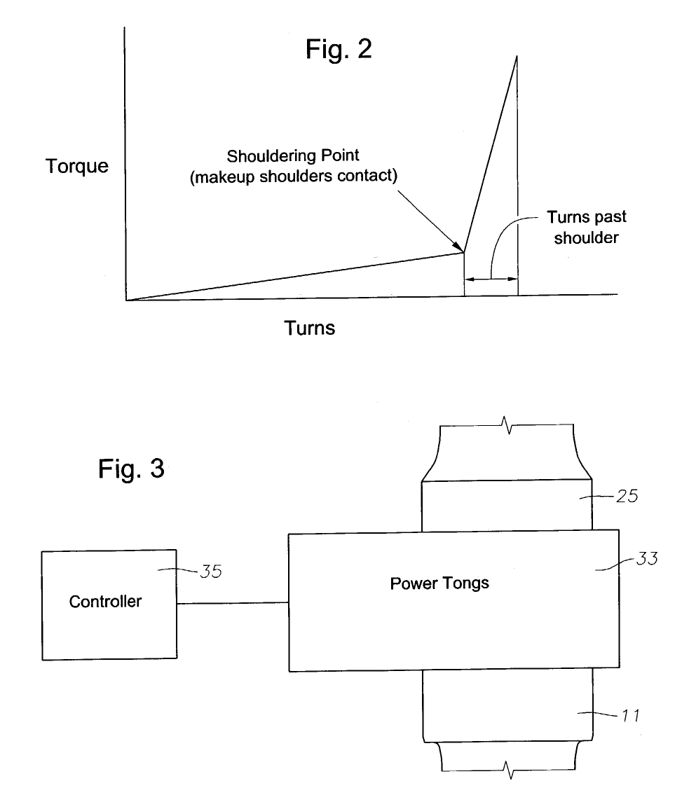

Referring to FIG. 2, once box 25 stabs into pin 11, the operator operates controller 35 to signal power tongs 33 to rotate box 25 while holding pin 11 stationary. As this rotation occurs, the torque gradually increases. FIG. 2 shows the slope to be linear, although in practice it will vary. The torque sensor within power tongs 33 provides this information continuously to the computer of controller 35. Once shoulders 19, 29 (FIG. 1) contact each other, the slope of the torque curve will rapidly increase as shown in FIG. 2. Controller 35 detects this sharp increase in torque and instructs power tongs 33 to rotate an additional amount equal to the preload rotational increment calculated above. In this example, controller 35 will instruct power tongs 33 to rotate the connection another 0.040 to 0.048 turns or another 2.194″ plus or minus 0.200 inches circumferentially. The additional amount of rotation is made without regard to t he amount of torque required.

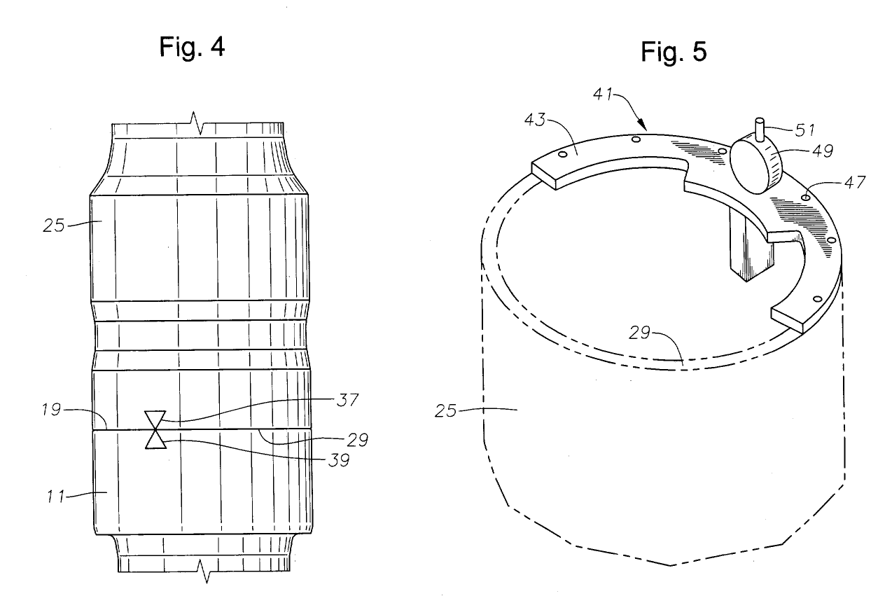

In a second embodiment, a controller having the ability to detect the shouldering point and instruct the power tongs to rotate for a preload increment is not required. Instead, pin 11 is pre-marked with an indicia 39 (FIG. 4), and box 25 is pre-marked with an indicia 37. Indicia 37, 39 are located on the circumference of the respective tubular members at the makeup shoulders 19, 29 (FIG. 1). The positioning of indicia 37, 39 is selected so that when the connection is made up with the full desired amount of preload, indicia 37 will align with indicia 39 within the given circumferential tolerance (in this example, plus or minus 0.200 inches) as shown in FIG. 4. The rotation to align indicia 37, 39 is made without regard to the actual torque required to reach the point of alignment.

FIG. 5 illustrates a gauge 41 for use in determining the location for indicia 37 of box 25. Gauge 41 has a base plate 43 that has a radius substantially the same as makeup shoulder 29. Base plate 43 is a curved ring, preferably extends for at least a portion of a full circle, and has a lower side configured for mating and rotating on makeup shoulder 29. A leg 45 is secured to base plate 43 and extends from it normal or perpendicular to the plane containing base plate 43. Plate 43 optionally may have a plurality of magnets 47 mounted to it to cause good attraction of base plate 43 to box makeup shoulder 29. A conventional micrometer 49 is mounted on the upper side of base plate 43. Micrometer 49 has a rod 51 that when moved axially will provide a distance measurement on the face of micrometer 49. Rod 51 passes slidingly through a passage 53 formed in leg 45.

A probe 55 is located at the lower end of and in engagement with rod 51. Probe 55 could be connected to rod 51 or simply placed in contact with the end of rod 51. Probe 55 protrudes radially outward through a slot 57 in leg 45. Slot 57 extends longitudinally along the length of leg 45 from passage 53 to allow probe 55 to move axially along passage 53. Probe 55 is perpendicular to the axis of rod 51.

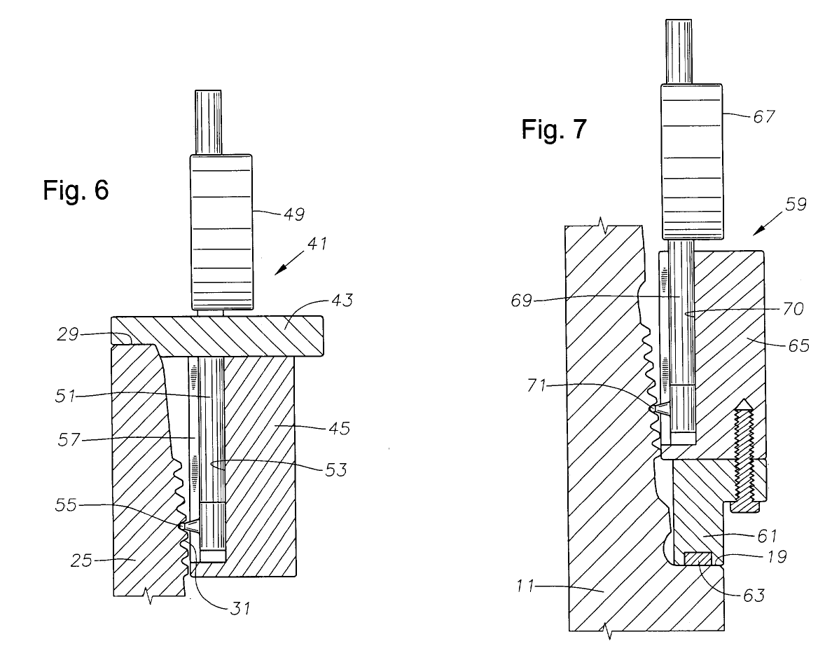

As indicated in FIG. 6, the free end of probe 55 is configured to locate within one of the threads 31 of box 25. In this embodiment, rod 51 is biased downward, but as probe 55 moves upward, it will push rod 51 upward. The gauge of micrometer 49 will read the distance between probe 55 and box makeup shoulder 29. As base plate 43 is rotating, the engagement of threads 31 with probe 55 will cause probe 55 to move either upward or downward due to the helical lead of the threads.

In this embodiment, an arbitrary reference distance is selected, such as two inches. The operator places base plate 43 on makeup shoulder 29 and rotates base plate 43 until probe 55 reaches the selected distance. There is only one point on box threads 31 that is at the selected reference distance from makeup shoulder 29, and this reference point on box threads 31 is marked by placing indicia 37 (FIG. 4) on the circumference of box 25 at the same circumferential position as the reference point. A mark (not shown) on base plate 43 is aligned axially with probe 55, and is used as a guide to position the location of indicia 37. Once marked, a radial plane passing through probe 55 from the axis of box 25 will pass through the center of indicia 37.

Referring to FIG. 7, a similar pin gauge 59 is employed to mark indicia 39 (FIG. 4) of pin 11. Pin gauge 59 also has a base plate 61 that is at least semi-circular. Base plate 61 may have magnets 63 and is configured with the same radius as makeup shoulder 19. A leg 65 extends upward from base plate 61. A micrometer 67 is located on the upper end of leg 65. A rod 69 extends through a passage 70 in leg 65. A probe 71 extends radially outward from passage 70 for engagement with pin threads 21.

In the operation of pin gauge 59, the operator places base plate 61 on makeup shoulder 29 and positions probe 55 in engagement with threads 21. The operator rotates base plate 61 until reaching a distance that corresponds to the pre-selected reference distance utilized with box 25, which was two inches in the example above. Probe 71 will be located at an equivalent reference point on threads 21 of pin 11 when at the corresponding distance. The reference points on threads 21 and 31 will touch each other when shoulders 19, 29 first contact each other. Note that the corresponding distance from the reference point on pin threads 21 to makeup shoulder 19 will likely not be precisely the same as the pre-selected reference distance for box 25. The reason that the corresponding distance is not the same as the pre-selected reference distance is that each probe 55, 71 preferably contacts a valley between two crests of the threadform. However, the true reference point on pin threads 21 is a crest, not a valley, because the pre-selected reference point was a valley on box threads 31. Consequently, the distance from the true reference point on pin threads 21 to makeup shoulder 19 will differ slightly from the pre-selected reference distance on box threads 111 because probe 71 does not contact the crest of a thread 21. This difference, which is equal to the axial distance from a valley to a crest, is readily measured or calculated, however so that the operator can add a compensating factor to the pre-selected distance to locate the true reference point on threads 21 that corresponds to the reference point on threads 31 (FIG. 6). The operator of gauge 59 also adds the preload axial deflection determined as above. If the preload deflection is 0.011″ plus or minus 0.001″ as in the example above, the operator then adds this to the compensating factor and the pre-selected reference distance, which was two inches in the example.

The operator then rotates base plate 61 until micrometer 67 reads the sum of the pre-selected reference distance plus the compensation factor plus the axial preload deflection. Once the operator reaches this point, he places indicia 39 (FIG. 4) on the circumference of pin 11 at makeup shoulder 19. A radial plane from the axis of pin 11 passes through probe 71 and the centerline of indicia 39. When connecting pin 11 and box 25, the operator rotates power tongs 33 (FIG. 3) until indicia 37 and 39 align with each other. This alignment indicates that the desired preload interference has been reached regardless of the amount of torque.

Although in the above example, the reference point for pin 11 was the sum of the box pre-selected reference distance plus the compensating factor and the shoulder interference, the process could alternately be reversed. Pin 11 could be marked with the pre-selected reference distance, and box 25 marked at the pre-selected reference distance plus the compensating factor and shoulder interference. Also, if one gauge is employed that measures to a crest and the other to a valley, the compensating factor would not be required.

A third method for achieving the desired amount of preload force is particularly applicable when only a few connections are to be made up, such as for test purposes. In this method, controller 35 (FIG. 3) is not required nor are the pin 11 and box 25 premarked. Rather, pin 11 and box 25 are stabbed together and rotated an arbitrary amount before initial contact of makeup shoulders 19 and 29 (FIG. 1). The operator then measures the gap between the shoulders. Knowing the lead or pitch of the threads 21, 31 (FIG. 1) and the amount of desired preload interference, the additional amount of rotation required to reach the preload interference can be easily calculated. For example, if the gap between makeup shoulders 19, 29 is 0.200″ at that point and the axial preload interference selected is 0.011″, the operator will divide the sum of the gap and the preload interference by the pitch, which is 0.250, yielding 0.844 turns left to achieve the desired preload. The outer diameter of the connector in the example above is 15.875″, thus the circumferential distance that the connector must turn from that point is pi ×15.875×0.844, or 42.092″. That final preload point can be marked from the first point where the gap is measured so that the operator can rotate the connection until those points line up.

If desired, the operator could measure the gap of one or more connections in this manner while recording the amount of torque encountered at full preload makeup to come up with a torque range. The operator could then connect subsequent sections of pipe using the torque as a guide rather than continuing to measure a gap at each connection. However, using torque as a guide would not be as accurate as measuring the gap and rotating the connection for a measured amount as described.

The invention has significant advantages. Connections can be made up to a precise specified preload force that is not dependent on the amount of torque measured. This reduces the variables and uncertainties of the prior art. The system can be used automatically for assembling long pipe strings with the use of a controller having a computer that detects the point of makeup shoulder contact and continues rotating the connection for a selected rotational increment for preloading. The manual method of pre-marking the box and pin allows operators to precisely preload the connections by aligning the marks without the necessity of a computer. Furthermore, the method of measuring the gap between makeup shoulders, then rotating for a calculated distance after the measurement, can be done with short pipe strings without the need for any specially made gauges.

While the invention has been shown in only three of its forms, it should be apparent to those skilled in the art that it is not so limited but is susceptible to various changes without departing from the scope of the invention.

We claim:

1. A method of making up a pipe connection having a box tubular member and a pin tubular member, the tubular members having mating threads and makeup shoulders, the method comprising:
(a) determining a desired axial preload interference between the makeup shoulders;
(b) determining an increment of preload rotation required between the tubular members after initial contact of the makeup shoulders to achieve the desired axial preload interference; and
(c) rotating one of the tubular members relative to the other tubular member past the initial contact of the makeup shoulders for an amount equal to the increment of preload rotation determined.

2. The method according to claim 1, wherein step (c) is performed without regard to the torque required.

3. The method according to claim 1, wherein step (b) is determined based on a pitch of the threads.

4. The method according to claim 1, wherein step (c) is performed by:
sensing torque that is encountered as said one of the tubular members is rotated relative to the other tubular member before initial contact of the makeup shoulders; then
sensing an increase in torque that is encountered once initial contact of the makeup shoulders occurs; then,
measuring the rotation occurring after the increase in torque is encountered until reaching the increment of preload rotation previously determined.

5. The method according to claim 1, wherein step (b) comprises placing indicia on the tubular members that align with each other when the increment of preload rotation is reached.

6. The method according to claim 1, wherein step (a) comprises selecting a desired preload force range, then calculating the amount of axial preload interference using finite element analysis.

7. A method of making up a pipe connection having a box tubular member and a pin tubular member, each of the tubular members having mating tapered threads and makeup shoulders, the method comprising:
(a) determining a desired axial preload interference between the makeup shoulders;
(b) determining an incremental amount of preload rotation required between the tubular members after initial contact of the makeup shoulders to achieve the desired axial preload interference;
(c) stabbing the tubular members together; then
(d) rotating one of the tubular members relative to the other tubular member while monitoring an amount of torque being incurred; then
(e) determining a point of initial contact of the makeup shoulders based on the rate of increase in the amount of torque being incurred; then
(f) rotating said one of the tubular members relative to the other tubular member for the incremental amount.

8. The method according to claim 7, wherein step (a) is determined by selecting a desired preload force range, then calculating the axial preload interference based on finite element analysis.

9. The method according to claim 7, wherein the rotation of step (f) stops at the incremental amount regardless of the amount of torque.

10. A method of making up a pipe connection having a box tubular member and a pin tubular member, the tubular members having mating threads and makeup shoulders, the method comprising:
(a) determining a desired axial preload interference between the makeup shoulders to achieve a desired preload force;
(b) determining an incremental amount of preload rotation required between the tubular members after initial contact of the makeup shoulders to achieve the desired axial preload interference;
(c) marking an indicia on an exterior portion of each of the tubular members at positions to align with each other when reaching the incremental amount of preload rotation; then
(d) rotating one of the tubular members relative to the other tubular member past initial contact of the makeup shoulders until the indicia align with each other.

11. The method of claim 10, wherein step (b) is performed by the following steps:
placing the indicia on a circumference of one of the tubular members at a place that corresponds rotationally to a pre-selected axial distance from one of the threads to the makeup shoulder; and
placing the indicia on a circumference of the other of the tubular members at a place that corresponds rotationally to the pre-selected axial distance from the makeup shoulder plus the desired axial preload interference.

12. The method of claim 10, wherein step (b) is performed on one of the tubular members by the following steps:
providing a first gauge having a base plate, a micrometer mounted to the base plate, the micrometer having a rod and a probe that extends radially from the rod;
placing the base plate on the makeup shoulder and the probe in engagement with one of the threads of one of the tubular members; then
rotating the base plate on the makeup shoulder, causing the probe to move along the threads and the rod to move axially until the micrometer reads a pre-selected distance; then
placing the indicia on a circumference of said one of the tubular members at a point within a radial plane that passes through the probe.

13. The method according to claim 11, wherein step (b) is performed on one of the tubular members by the following steps:
providing a second gauge having a base plate, a micrometer mounted to the base plate, the micrometer having a rod and a probe that extends radially from the rod;
placing the base plate of the second gauge on the makeup shoulder and the probe in engagement with one of the threads of the other of the tubular members; then
rotating the base plate on the makeup shoulder, causing the probe to move along the threads and the rod to move axially until the micrometer reads an amount corresponding to the pre-selected distance plus the axial preload interference; then
placing the indicia on a circumference of the other of the tubular members at a point within a radial plane that passes through the probe.

14. A method of making up a pipe connection having a box tubular member and a pin tubular member, the tubular members having mating threads and makeup shoulders, the method comprising:
(a) determining a desired axial preload interference between the makeup shoulders to achieve a desired preload force;
(b) determining an incremental amount of preload rotation required between the tubular members after initial contact of the makeup shoulders to achieve the desired axial preload interference;
(c) stabbing the tubular members into engagement with each other and rotating one of the tubular members relative to the other of the tubular members to a first point that is prior to initial contact of the makeup shoulders; then
(d) measuring the distance between the shoulders at the first point; then
(e) determining the amount of rotation required to reach the desired axial preload interference from the first point; then
(d) rotating one of the tubular members relative to the other tubular member for the determined amount of rotation.

15. The method according to claim 14, further comprising:
measuring a preload torque encountered when reaching the desired axial preload; and
connecting subsequent sets of tubular members together by rotating the tubular members relative to each other until the preload torque measured is reached.

16. The method according to claim 14, wherein step (e) comprises adding the distance between the shoulders at the first point to the axial deflection and dividing the sum by the pitch of the threads.

17. A pipe connection, comprising:
a box tubular member having a set of helical threads and a makeup shoulder;
a pin tubular member having mating threads and a makeup shoulder;
a first indicia on a circumference of one of the tubular members that is located in a radial plane passing from an axis of said one of the tubular members through a point at a pre-selected axial distance from one of the threads to the makeup shoulder;
a second indicia on a circumference of the other of the tubular members that is located in a radial plane passing from an axis of said other of the tubular members through a point that corresponds rotationally to the pre-selected axial distance from the makeup shoulder plus the desired axial preload interference; and
wherein making up the tubular members to each other results in a desired preload through the makeup shoulders when the first and second indicia align with each other.

18. The connection according to claim 17, wherein:
the makeup shoulder of the box tubular member is on a rim of the box tubular member, and the indicia on the box tubular member is located adjacent the rim; and
the makeup shoulder of the pin tubular member is at a base of the threads of the pin tubular member, and the indicia on the pin tubular member is located adjacent the makeup shoulder of the pin tubular member.

19. A gauge, comprising:
a base plate adapted to fit flush on a makeup shoulder of a tubular member;
a micrometer mounted to the base plate, the micrometer having a movable rod extending normal to the base plate;
a probe in engagement with the rod and extending transversely therefrom for engaging a thread of the tubular member; whereby
rotating the base plate on the makeup shoulder causes the probe to move along the thread, thereby causing the rod to move axially and provide a reading on the micrometer corresponding to the distance from the probe to the makeup shoulder.

20. The gauge according to claim 19, wherein the base plate is curved at a radius selected to match a radius of the makeup shoulder.

21. The gauge according to claim 19, further comprising:
a leg rigidly mounted to the base plate and extending normal therefrom;
a passage within the leg that receives the rod of the micrometer, the rod being axially movable in the passage; and
a longitudinal slot extending from the passage through which the probe extends.

22. The gauge according to claim 19, further comprising at least one magnet mounted to the base plate for adhering the base plate to the makeup shoulder.
